(19) United States
(12) Patent Application Publication
(10) Pub. No.: US 2026/0261223 A1
(43) Pub. Date: Sep. 3, 2026

(54) MOTOR CONTROL APPARATUS AND MECHANICAL APPARATUS

(71) Applicant: Mitsubishi Electric Corporation, Tokyo (JP)

(72) Inventors: Shinji OKUMURA, Tokyo (JP); Hiroyuki SEKIGUCHI, Tokyo (JP); Sho UENO, Tokyo (JP)

(73) Assignee: Mitsubishi Electric Corporation, Tokyo (JP)

(21) Appl. No.: 18/871,283

(22) PCT Filed: Jun. 9, 2022
(86) PCT No.: PCT/JP2022/023297

§ 371 Date: Dec. 3, 2024

(51) Int. Cl. H02P 23/00; H02P 5/00

(52) U.S. Cl. CPC H02P 23/0022; H02P 5/00

(57) ABSTRACT

A motor control apparatus includes: a first electric motor and a second electric motor installed on a support structure; a second controller that determines a second deviation reduction signal, the second deviation reduction signal being a signal for driving the second electric motor in such a way as to reduce a difference between a signal based on a second position command and a second electric motor position signal, the second position command specifying a position of a mover of the second electric motor a support-structure state estimator that determines a support-structure model position based on a reference driving force signal; a correction amount determiner that determines a displacement correction signal based on the support-structure model position; and a computing unit that determines a corrected motor drive signal based on the displacement correction signal and the second deviation reduction signal.

### FIELD

The present disclosure relates to a motor control apparatus and a mechanical apparatus for controlling a plurality of electric motors installed on a support structure.

### BACKGROUND

High-speed and high-accuracy control performance is required for industrial machines such as electronic component mounting machines, exposure devices, and machine tools. An apparatus including two electric motors installed on a support structure can be cited as an example of industrial machines. Control performance of one of the electric motors of the apparatus may deteriorate due to the effect of acceleration/deceleration of the other electric motor. Thus, there is a demand for control for decoupling the influence of shafts on each other.

In a disturbance decoupling compensation apparatus for a positioning control system, described in Patent Literature 1, a disturbance decoupling compensator, which performs disturbance decoupling compensation on the observation amount of a driver to be affected by disturbance, includes a first feedforward compensator Fₙₗ(s) and a first computing unit. The first feedforward compensator Fₙₗ(s) receives input of an operation amount u_{b} of the driver to be affected by disturbance, and outputs a feedforward compensation amount uc for performing the disturbance decoupling compensation on an observation amount xₗₘ of the driver to be affected by disturbance. The first computing unit corrects the output of an operation amount C₁(s) of the driver to be affected by disturbance by using the output of the first feedforward compensator Fₙₗ(s).

### CITATION LIST

### Patent Literature

Patent Literature 1: Japanese Patent Application Laid-open No. 2010-204878

### SUMMARY OF INVENTION

### Problem to be Solved by the Invention

However, the disturbance decoupling compensation apparatus for a positioning control system, described in Patent Literature 1 has a problem in that it takes a long time to adjust a compensator that decouples influence of shafts on each other. That is, the conventional technique has a problem in that it is not possible to provide a motor control apparatus capable of adjusting, in a short time, a compensator that decouples influence of shafts on each other and preventing interference between the shafts.

The present disclosure has been made in view of the above, and an object of the present disclosure is to provide a motor control apparatus capable of preventing interference between shafts and adjusting a compensator that decouples influence of the shafts on each other in a short time.

### Means to Solve the Problem

In order to solve the above-described problems and achieve the object, a motor control apparatus according to the present disclosure includes: a first electric motor installed on a support structure; a second electric motor installed on the support structure, the second electric motor being different from the first electric motor; and a second controller that determines a second deviation reduction signal, the second deviation reduction signal being a signal for driving the second electric motor in such a way as to reduce a difference between a signal based on a second position command and a second electric motor position signal, the second position command specifying a position of a mover of the second electric motor, the second electric motor position signal indicating a position of the mover of the second electric motor relative to a stator of the second electric motor. The motor control apparatus according to the present disclosure further includes: a support-structure state estimator that determines a support-structure model position based on a reference driving force signal, the reference driving force signal being a signal representing a force for driving a mover of the first electric motor, the support-structure model position being an estimated value of an absolute position of the support structure that is elastically deformed by a reaction force of driving of the mover of the first electric motor; a correction amount determiner that determines a displacement correction signal based on the support-structure model position determined by the support-structure state estimator; and a computing unit that determines a corrected motor drive signal based on the displacement correction signal and the second deviation reduction signal, the second electric motor being driven by the corrected motor drive signal, the displacement correction signal being determined by the correction amount determiner, the second deviation reduction signal being determined by the second controller.

### Effects of the Invention

The motor control apparatus according to the present disclosure has an effect of enabling prevention of interference between shafts and enabling a compensator that decouples influence of the shafts on each other to be adjusted in a short time.

### BRIEF DESCRIPTION OF DRAWINGS

FIG. 1 is a top view of a mechanical apparatus including two electric motors.

FIG. 2 is a side view of the mechanical apparatus including the two electric motors.

FIG. 3 is a diagram illustrating a configuration of a system including a motor control apparatus according to a first embodiment.

FIG. 4 is a diagram obtained by equivalent transformation of FIG. 3.

FIG. 5 is a diagram illustrating a configuration of an input device according to the first embodiment.

FIG. 6 is a Bode diagram illustrating a frequency response of a mechanical apparatus subjected to an experiment according to the first embodiment, the frequency response being from a first deviation reduction signal to a second machine-end relative displacement.

FIG. 7 is a diagram illustrating a first position command.

FIG. 8 is a diagram illustrating a result of an experiment of comparison between responses made when positioning operation was performed in a case where the motor control apparatus according to the first embodiment was used and in a case where the motor control apparatus according to the first embodiment was not used.

FIG. 9 is a diagram illustrating a configuration of a system including a motor control apparatus according to a second embodiment.

FIG. 10 is a diagram illustrating a processor that implements at least some of functions of a first controller, detectors, a second controller, a support-structure state estimator, a correction amount determiner, and a computing unit included in the motor control apparatus according to the first embodiment.

FIG. 11 is a diagram illustrating processing circuitry that implements at least some of the functions of the first controller, the detectors, the second controller, the support-structure state estimator, the correction amount determiner, and the computing unit included in the motor control apparatus according to the first embodiment.

### DESCRIPTION OF EMBODIMENTS

Hereinafter, motor control apparatuses and a mechanical apparatus according to embodiments will be described in detail with reference to the drawings.

### First Embodiment

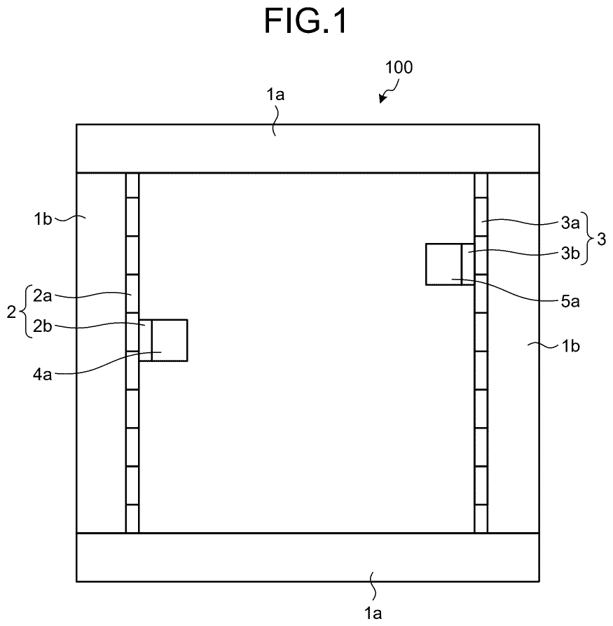

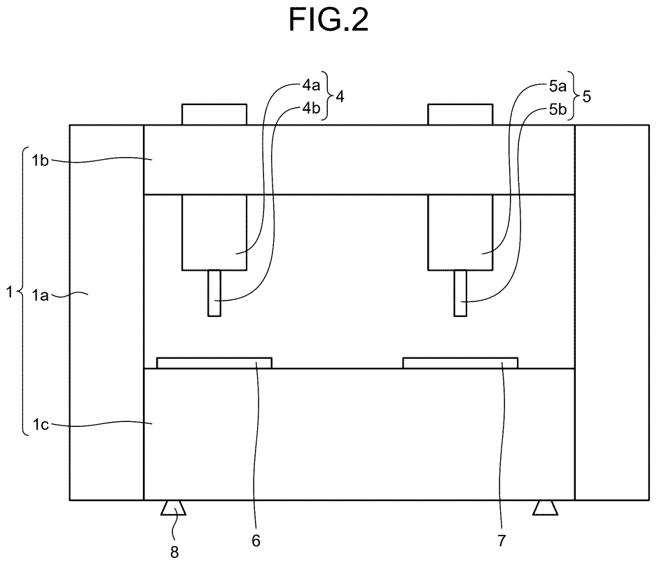

FIG. 1 is a top view of a mechanical apparatus 100 including two electric motors. FIG. 2 is a side view of the mechanical apparatus 100 including the two electric motors. FIGS. 1 and 2 schematically illustrate the mechanical apparatus 100 including the two electric motors. The mechanical apparatus 100 illustrated in FIGS. 1 and 2 includes a support structure 1, a first electric motor 2, a second electric motor 3, a first driver 4, and a second driver 5. The support structure 1 is supported by leveling blocks 8. The first electric motor 2 and the second electric motor 3 are fixed to the support structure 1. The first driver 4 is driven by the first electric motor 2. The second driver 5 is driven by the second electric motor 3. The second electric motor 3 is an electric motor different from the first electric motor 2.

The support structure 1 includes a support structure lower portion 1c, support structure side surfaces 1a, and support structure upper portions 1b. The support structure side surfaces 1a are installed on the support structure lower portion 1c. The support structure upper portions 1b are installed on the support structure side surfaces 1a. The first electric motor 2 includes a stator 2a and a mover 2b. The stator 2a is fixed to the support structure upper portion 1b. The mover 2b moves in a longitudinal direction of the stator 2a. The second electric motor 3 includes a stator 3a and a mover 3b. The stator 3a is fixed to the support structure upper portion 1b. The mover 3b moves in a longitudinal direction of the stator 3a. In the first embodiment, the first electric motor 2 and the second electric motor 3 are linear motors. The first electric motor 2 and the second electric motor 3 are not limited to linear motors, and may be rotary motors.

The first driver 4 includes a drive unit 4a and a work tool 4b. The drive unit 4a is installed on the mover 2b, and operates integrally with the mover 2b. The work tool 4b is fixed to a tip of the drive unit 4a. The second driver 5 includes a drive unit 5a and a work tool 5b. The drive unit 5a is installed on the mover 3b, and operates integrally with the mover 3b. The work tool 5b is fixed to a tip of the drive unit 5a. In the first embodiment, the work tool 4b and the work tool 5b are tools. The work tool 4b and the work tool 5b are not limited to tools, and may be robot hands. In the first embodiment, a workpiece 6 placed on the support structure lower portion 1c is machined by the work tool 4b. A workpiece 7 placed on the support structure lower portion 1c is machined by the work tool 5b.

In the first embodiment, in order to facilitate understanding of the effect of the motor control apparatus according to the first embodiment, a mechanical apparatus including two electric motors will be described as an apparatus to be controlled. The effect of the motor control apparatus according to the first embodiment can also be obtained for a mechanical apparatus including three or more electric motors.

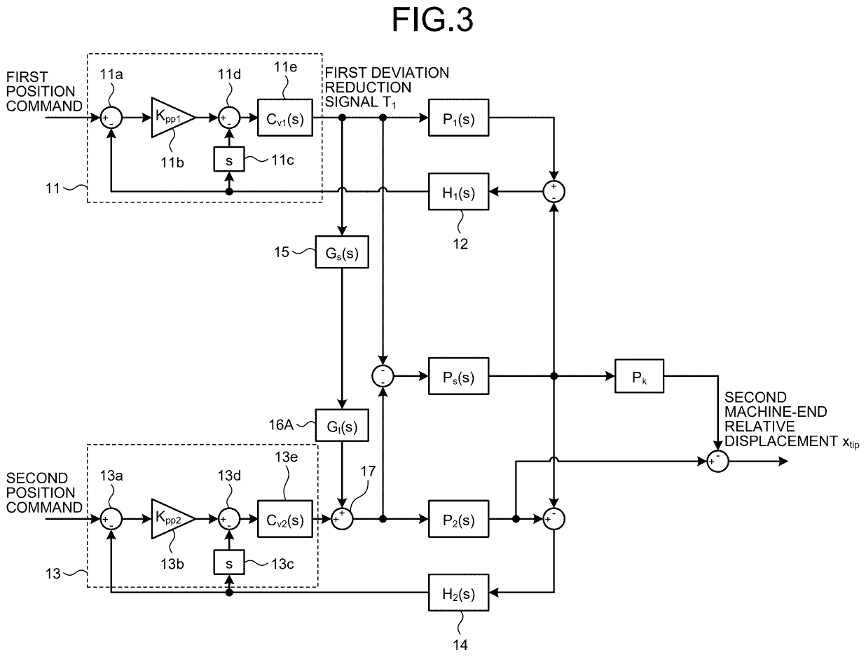

FIG. 3 is a diagram illustrating a configuration of a system including the motor control apparatus according to the first embodiment. In the first embodiment, in order to facilitate understanding of the structure of the system, a description will be given of matters related to the case of preventing control performance of the second electric motor 3 from being deteriorated due to the driving of the first electric motor 2. The motor control apparatus according to the first embodiment can also be applied to the case of preventing control performance of the first electric motor 2 from being deteriorated due to the driving of the second electric motor 3 and the case of preventing the control performance of the second electric motor 3 from being deteriorated due to the driving of the first electric motor 2 and preventing the control performance of the first electric motor 2 from being deteriorated due to the driving of the second electric motor 3.

The motor control apparatus according to the first embodiment includes the first electric motor 2 and the second electric motor 3 installed on the support structure 1. The motor control apparatus according to the first embodiment further includes a first controller 11 that determines a first deviation reduction signal T₁ based on a first position command and a first electric motor position signal. The first deviation reduction signal T₁ is a signal for driving the first electric motor 2 in such a way as to reduce a difference between the first position command and the first electric motor position signal. The first position command determines a position of the mover 2b of the first electric motor 2. The mover 2b is driven based on the first deviation reduction signal T₁. In the first embodiment, the first deviation reduction signal T₁ corresponds to a reference driving force signal. The motor control apparatus according to the first embodiment further includes a detector 12 that detects a first motor-end relative displacement. The first motor-end relative displacement refers to the position of the mover 2b of the first electric motor 2 relative to the support structure 1. The first electric motor position signal indicates the first motor-end relative displacement detected by the detector 12. A transfer characteristic H₁ from the first motor-end relative displacement to the first electric motor position signal is expressed by formula (1) below.

$$\begin{matrix}Formula 1 & \\ {H}_{1} = 1 & ( 1 )\end{matrix}$$

The first controller 11 includes a computing unit 11a and a proportional gain output unit 11b. The computing unit 11a outputs a first position deviation signal obtained by subtraction of the first electric motor position signal from the first position command. The proportional gain output unit 11b outputs a first speed correction signal obtained by multiplication of the first position deviation signal by Kₚₚ₁. The first controller 11 further includes a differentiator 11c and a computing unit 11d. The differentiator 11c differentiates the first electric motor position signal. The computing unit 11d outputs a first speed deviation signal based on the first speed correction signal and a signal obtained by the differentiator 11c differentiating the first electric motor position signal. Specifically, the computing unit 11d subtracts the signal obtained by the differentiator 11c differentiating the first electric motor position signal from the first speed correction signal, and outputs the first speed deviation signal. The first controller 11 further includes a first speed controller 11e that outputs the first deviation reduction signal T₁ based on the first speed deviation signal. In the first embodiment, the first speed controller 11e is a Propotional Integral (PI) controller. A transfer characteristic Cᵥ₁(s) of the first speed controller 11e is expressed by formula (2) below.

$$\begin{matrix}Formula 2 & \\ {C}_{v 1} ( s ) = {K}_{vp 1} + \frac{{K}_{vt 1}}{s} & ( 2 )\end{matrix}$$

The symbol “s” denotes a Laplace operator. The symbol “Kᵥₚ₁” denotes proportional gain of speed control, and the symbol “Kᵥᵢ₁” denotes integral gain of speed control. A transfer characteristic C₁(s) from the first electric motor position signal to the first deviation reduction signal T₁ can be expressed by formula (3) below.

$$\begin{matrix}Formula 3 & \\ {C}_{1} ( s ) = - {K}_{pp 1} - ( {K}_{vp 1} + \frac{{K}_{vi 1}}{s} ) \cdot s & ( 3 )\end{matrix}$$

In the first embodiment, the first controller 11 is a P-PI controller. The first controller 11 is not limited to the P-PI controller, and may be a proportional-integral-differential (PID) controller.

The motor control apparatus according to the first embodiment further includes a second controller 13 that determines a second deviation reduction signal based on a second position command and a second electric motor position signal. The second deviation reduction signal is a signal for driving the second electric motor 3 in such a way as to reduce a difference between the second position command and the second electric motor position signal. The second position command determines a position of the mover 3b of the second electric motor 3. More specifically, the second controller 13 determines the second deviation reduction signal that is a signal for driving the second electric motor 3 in such a way as to reduce a difference between a signal based on the second position command and the second electric motor position signal. The second position command specifies the position of the mover 3b of the second electric motor 3. The second electric motor position signal indicates a position of the mover 3b of the second electric motor 3 relative to the stator 3a of the second electric motor 3. The motor control apparatus according to the first embodiment further includes a detector 14 that detects a second motor-end relative displacement. The second motor-end relative displacement is a position of the mover 3b of the second electric motor 3 relative to the support structure 1. The second electric motor position signal indicates the second motor-end relative displacement detected by the detector 14. A transfer characteristic H₂ from the second motor-end relative displacement to the second electric motor position signal is expressed by formula (4) below.

$$\begin{matrix}Formula 4 & \\ {H}_{2} = 1 & ( 4 )\end{matrix}$$

The second controller 13 includes a computing unit 13a and a proportional gain output unit 13b. The computing unit 13a outputs a second position deviation signal obtained by subtraction of the second electric motor position signal from the second position command. The proportional gain output unit 13b outputs a second speed correction signal obtained by multiplication of the second position deviation signal by Kₚₚ₂. The second controller 13 further includes a differentiator 13c and a computing unit 13d. The differentiator 13c differentiates the second electric motor position signal. The computing unit 13d outputs a second speed deviation signal based on the second speed correction signal and a signal obtained by the differentiator 13c differentiating the second electric motor position signal. Specifically, the computing unit 13d subtracts the signal obtained by the differentiator 13c differentiating the second electric motor position signal from the second speed correction signal, and outputs the second speed deviation signal. The second controller 13 further includes a second speed controller 13e that outputs the second deviation reduction signal based on the second speed deviation signal. In the first embodiment, the second speed controller 13e is a PI controller, and a transfer characteristic C_{V2}(s) of the second speed controller 13e is expressed by formula (5) below.

$$\begin{matrix}Formula 5 & \\ {C}_{v 2} ( s ) = {K}_{vp 2} + \frac{{K}_{vi 2}}{s} & ( 5 )\end{matrix}$$

The symbol “Kᵥₚ₂” denotes proportional gain of speed control, and the symbol “Kᵥᵢ₂” denotes integral gain of speed control. A transfer characteristic C₂(s) from the second electric motor position signal to the second deviation reduction signal can be expressed by formula (6) below.

$$\begin{matrix}Formula 6 & \\ {C}_{2} ( s ) = - {K}_{pp 2} - ( {K}_{vp 2} + \frac{{K}_{vi 2}}{s} ) \cdot s & ( 6 )\end{matrix}$$

In the first embodiment, C₂(s) expressed by formula (6) is the transfer characteristic of the second controller 13. In the first embodiment, the second controller 13 is a P-PI controller. The second controller 13 is not limited to the P-PI controller, and may be a PID controller.

The motor control apparatus according to the first embodiment further includes a support-structure state estimator 15 that determines support-structure model positions based on the first deviation reduction signal T₁. The support-structure model positions are estimated values of absolute positions of the support structure upper portions 1b in the support structure 1 that is elastically deformed by reaction forces of the driving of the mover 2b and the mover 3b. More specifically, the support-structure state estimator 15 determines a support-structure model position that is an estimated value of an absolute position of the support structure 1 that is elastically deformed by a reaction force of the driving of the mover 2b of the first electric motor 2, based on a reference driving force signal that is a signal representing a force for driving the mover 2b of the first electric motor 2. The motor control apparatus according to the first embodiment further includes a correction amount determiner 16A that determines a displacement correction signal based on the support-structure model position determined by the support-structure state estimator 15. The transfer characteristic of the support-structure state estimator 15 is represented as Gₛ(s), and the transfer characteristic of the correction amount determiner 16A is represented as Gt(s).

The motor control apparatus according to the first embodiment further includes a computing unit 17 that determines and outputs a corrected motor drive signal for driving the second electric motor 3, based on the second deviation reduction signal determined by the second controller 13 and the displacement correction signal determined by the correction amount determiner 16A. Specifically, the computing unit 17 adds the second deviation reduction signal output by the second speed controller 13e and the displacement correction signal determined by the correction amount determiner 16A, and outputs a corrected motor drive signal. The mover 3b of the second electric motor 3 is driven based on the corrected motor drive signal.

Next, a description will be given of a process of deriving the transfer characteristic Gₛ(s) of the support-structure state estimator 15 and the transfer characteristic Gₜ(s) of the correction amount determiner 16A.

The symbol “P₁(s)” denotes a model representing characteristics from the first deviation reduction signal T₁ to the position of the mover 2b of first electric motor 2. The symbol “P₂(s)” denotes a model representing characteristics from the second deviation reduction signal to the position of the mover 3b of the second electric motor 3. Assuming that P₁(s) and P₂(s) denote rigid models, P₁(s) can be expressed by formula (7) below, and P₂(s) can be expressed by formula (8) below.

$$\begin{matrix}Formula 7 & \\ {P}_{1} ( s ) = \frac{1}{{m}_{1} {s}^{2}} & ( 7 )\end{matrix}$$

$$\begin{matrix}Formula 8 & \\ {P}_{2} ( s ) = \frac{1}{{m}_{2} {s}^{2}} & ( 8 )\end{matrix}$$

The symbol “m” denotes the sum of the mass of the mover 2b of the first electric motor 2 and the mass of the first driver 4. The symbol “m₂” denotes the sum of the mass of the mover 3b of the second electric motor 3 and the mass of the second driver 5.

The symbol “Pₛ(s)” denotes a model representing characteristics from forces to be applied to the support structure 1 to the positions of the support structure upper portions 1b. Here, the forces to be applied to the support structure 1 are reaction forces caused by the driving of the first electric motor 2 and the second electric motor 3. When the first electric motor 2 and the second electric motor 3 are driven, the reaction forces caused by the driving are propagated to the support structure 1. As a result, the support structure 1 is elastically deformed due to the low rigidity of the support structure 1. When the displacement of the support structure 1 is modeled by a spring-mass-damper system, Pₛ(s) can be expressed by formula (9) below.

$$\begin{matrix}Formula 9 & \\ {P}_{s} ( s ) = \frac{1}{{M}_{b} {s}^{2} + {D}_{b} s + {K}_{b}} & ( 9 )\end{matrix}$$

The symbol “K_{b}” denotes a spring constant, the symbol “D_{b}” denotes a damping coefficient, and the symbol “M_{b}” denotes a mass of the support structure 1. As shown in formula (9), the transfer function of the support structure 1 is expressed by a second-order vibration system. Assuming that the model of the support structure 1 represented by formula (9) includes resonance characteristics, the pole of formula (9) is a complex number. It is possible to model the support structure 1, including the resonance characteristics of the support structure 1, by expressing the model of the support structure 1 with a second-order vibration system in this manner. Here, in the first embodiment, the transfer function of the support structure 1 has been expressed by a second-order vibration system for simplification. However, in order to express complicated vibration characteristics, the transfer function may be modeled by a vibration system of third order or more.

Here, it is assumed that the support structure 1 vibrates in a rocking mode. When the support structure 1 vibrates in the rocking mode, the support structure 1 vibrates while rotating about the leveling block 8. At this time, it is possible to obtain a model in which the support structure upper portions 1b and the support structure lower portion 1c vibrate at the same frequency in the same phase with different amplitudes. Thus, positions Xu of the support structure upper portions 1b can be expressed by formula (10) below, and a position xd of the support structure lower portion 1c can be expressed by formula (11) below.

$$\begin{matrix}Formula 10 & \\ {x}_{u} = {Ae}^{ζ t} cos ( ω t + α ) & ( 10 )\end{matrix}$$

$$\begin{matrix}Formula 11 & \\ {x}_{d} = {Be}^{ζ t} cos ( ω t + α ) & ( 11 )\end{matrix}$$

The symbol “A” denotes the maximum amplitude of the support structure upper portions 1b, the symbol “B” denotes the maximum amplitude of the support structure lower portion 1c, the symbol “ζ” denotes a damping ratio, the symbol “t” denotes time, the symbol “ω” denotes a natural angular frequency, and the symbol “α” denotes an initial phase. That is, it is possible to express the position x_{d} of the support structure lower portion 1c with formula (12) below by using the positions xᵤ of the support structure upper portions 1b and a support-structure vibration amplitude ratio Pₖ=B/A, which is the ratio of the maximum amplitude B of the support structure lower portion 1c to the maximum amplitude A of the support structure upper portions 1b.

$$\begin{matrix}Formula 12 & \\ {x}_{d} = {P}_{k} \cdot {x}_{u} & ( 12 )\end{matrix}$$

In FIG. 3, a transfer function from the first deviation reduction signal T₁ to a second machine-end relative displacement xₜᵢₚ obtained by subtraction of the position of the support structure lower portion 1c from the position of the mover 3b of the second electric motor 3 can be expressed by formula (13) below. Note that H1=1 and H2=1 have been substituted thereinto.

$$\begin{matrix}Formula 13 & \\ \frac{{x}_{tip}}{{T}_{1}} = ( {P}_{k} \cdot {P}_{s} ( s ) + \frac{{G}_{s} ( s ) {G}_{t} ( s ) + {C}_{2} ( s ) {P}_{s} ( s )}{1 - {C}_{2} ( s ) ( {P}_{s} ( s ) + {P}_{2} ( s ) )} ( {P}_{2} ( s ) + {P}_{k} \cdot {P}_{s} ( s ) ) ) & ( 13 )\end{matrix}$$

Formula (14) below is obtained from formula (13). Formula (14) shows that in order for the second machine-end relative displacement xₜᵢₚ to be zero, formula (15) below just needs to be satisfied.

$$\begin{matrix}Formula 14 & \\ {x}_{tip} = ( {P}_{k} \cdot {P}_{s} ( s ) + \frac{{G}_{s} ( s ) {G}_{t} ( s ) + {C}_{2} ( s ) {P}_{s} ( s )}{1 - {C}_{2} ( s ) ( {P}_{s} ( s ) + {P}_{2} ( s ) )} ( {P}_{2} ( s ) + {P}_{k} \cdot {P}_{s} ( s ) ) ) {T}_{1} & ( 14 )\end{matrix}$$

$$\begin{matrix}Formula 15 & \\ {G}_{s} ( s ) {G}_{t} ( s ) = \frac{- {C}_{2} ( s ) {P}_{2} ( s ) {P}_{s} ( s ) ( 1 - {P}_{k} ) - {P}_{k} {P}_{s} ( s )}{{P}_{2} + {P}_{k} \cdot {P}_{s}} & ( 15 )\end{matrix}$$

It is possible to obtain formula (16) below by substituting formula (7), formula (8), and formula (9) into formula (15).

$$\begin{matrix}Formula 16 & \\ {G}_{s} ( s ) {G}_{t} ( s ) = \frac{- ( 1 - {P}_{k} ) {C}_{2} ( s ) - {P}_{k} \cdot {m}_{2} {s}^{2}}{( {M}_{b} + {m}_{2} \cdot {P}_{k} ) {s}^{2} + {D}_{b} s + {K}_{b}} & ( 16 )\end{matrix}$$

In general, since the mass of the support structure 1 is sufficiently larger than the sum of the mass of the mover 3b and the mass of the second driver 5, formula (17) below is obtained. Formula (17) is an approximate expression.

$$\begin{matrix}Formula 17 & \\ {M}_{b} + {m}_{2} ≅ {M}_{b} & ( 17 )\end{matrix}$$

Since the support-structure vibration amplitude ratio Pₖ generally satisfies 0≤Pₖ≤1, formula (18) below is obtained. Formula (18) is an approximate expression.

$$\begin{matrix}Formula 18 & \\ {M}_{b} + {m}_{2} \cdot {P}_{k} ≅ {M}_{b} & ( 18 )\end{matrix}$$

It is possible to obtain formula (19) by substituting formula (17) and formula (18) into formula (16).

$$\begin{matrix}Formula 19 & \\ {G}_{s} ( s ) {G}_{t} ( s ) = \frac{- ( 1 - {P}_{k} ) {C}_{2} ( s ) - {P}_{k} \cdot {m}_{2} {s}^{2}}{{M}_{b} {s}^{2} + {D}_{b} s + {K}_{b}} & ( 19 )\end{matrix}$$

The transfer characteristic Gₛ(s) is represented by formula (20) below, and the transfer characteristic Gₜ(s) is represented by formula (21) below.

$$\begin{matrix}Formula 20 & \\ {G}_{s} ( s ) = \frac{1}{{M}_{b} {s}^{2} + {D}_{b} s + {K}_{b}} & ( 20 )\end{matrix}$$

$$\begin{matrix}Formula 21 & \\ {G}_{t} ( s ) = - ( 1 - {P}_{k} ) {C}_{2} ( s ) - {P}_{k} \cdot {m}_{2} {s}^{2} & ( 21 )\end{matrix}$$

Since Gₛ(s) matches Pₛ(s), it is found that Gₛ(s) is a transfer function of the model of the support structure 1. That is, the support-structure state estimator 15 estimates the position of the support structure 1 based on the first deviation reduction signal T₁. Since the support-structure state estimator 15 is a second-order vibration system in the first embodiment, the support-structure state estimator 15 can calculate a support-structure model position including the resonance characteristics of the support structure 1. Therefore, the support-structure state estimator 15 can perform decoupling including the resonance characteristics of the support structure 1. In addition, when the support structure 1 is modeled by a vibration system of third order or more, the support-structure state estimator 15 is a vibration system of third order or more. In this manner, the support-structure state estimator 15 performs calculation represented by a transfer function including the second-order vibration system.

When ζₙ denotes the damping ratio of the support structure 1 and ωₙ denotes the natural angular frequency of the support structure 1, formula (20) can also be expressed as formula (22) below.

$$\begin{matrix}Formula 22 & \\ {G}_{s} ( s ) = \frac{1}{{s}^{2} + 2 {ω}_{n} {ζ}_{n} s + {ω}_{n}^{2}} \frac{1}{{M}_{b}} & ( 22 )\end{matrix}$$

The characteristics of the support-structure state estimator 15 are determined based on the mass Mb of the support structure 1, the viscous friction coefficient Db, and the spring constant K_{b} in formula (20) and the natural angular frequency ωₙ and the damping ratio ζₙ in formula (22). Since ζₙ represents resonance of the support structure 1, a value of 0 or more and less than 1 is preferably set to ζₙ. The characteristics of the correction amount determiner 16A are determined based on the transfer characteristic C₂(s) of the second controller 13, the support-structure vibration amplitude ratio Pₖ, and m₂ that is the sum of the mass of the mover 3b of the second electric motor 3 and the mass of the second driver 5.

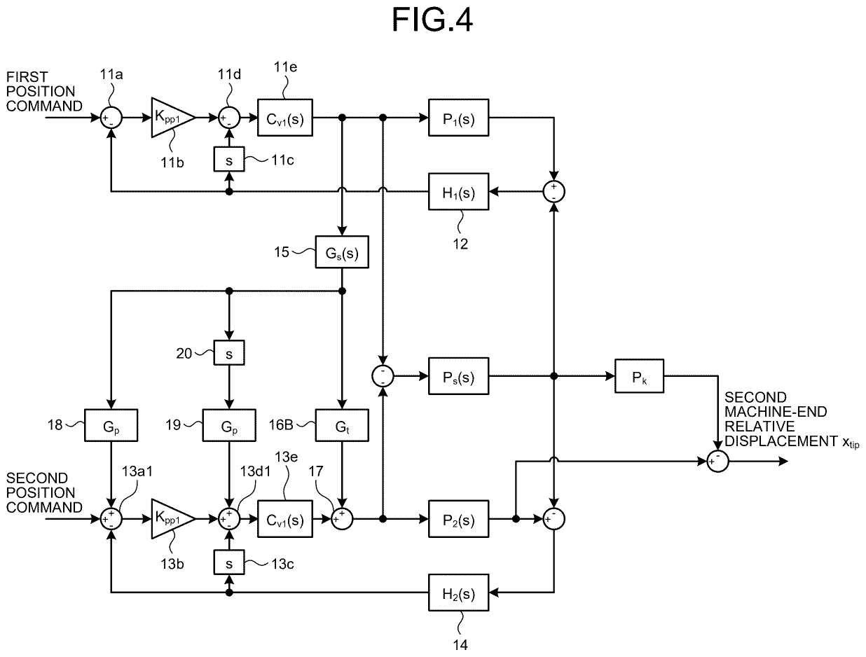

In the first embodiment, the block diagram illustrating the configuration of the system including the motor control apparatus corresponds to FIG. 3. Meanwhile, the block diagram illustrating the configuration of the system including the motor control apparatus according to the first embodiment is not limited to FIG. 3, and may be a diagram obtained by equivalent transformation of FIG. 3. For example, FIG. 4 is a diagram obtained by equivalent transformation of FIG. 3. A motor control apparatus illustrated in FIG. 4 can obtain the same effect as the motor control apparatus illustrated in FIG. 1.

In a system illustrated in FIG. 4, the computing unit 13d in FIG. 3 has been replaced with a computing unit 13d1. The system illustrated in FIG. 4 includes a position change corrector 18 and a speed change corrector 19. The position change corrector 18 and the speed change corrector 19 have the same transfer characteristics, and a transfer characteristic Gₚ of the position change corrector 18 and the speed change corrector 19 is expressed by formula (23) below.

$$\begin{matrix}Formula 23 & \\ {G}_{p} = 1 - {P}_{k} & ( 23 )\end{matrix}$$

The motor control apparatus illustrated in FIG. 4 includes a correction amount determiner 16B. A transfer characteristic G_{τ} of the correction amount determiner 16B is expressed by formula (24) below.

$$\begin{matrix}Formula 24 & \\ {G}_{r} = - {P}_{k} {m}_{2} {s}^{2} & ( 24 )\end{matrix}$$

Here, Gₛ(s) in FIG. 4 is the same as Gₛ(s) in FIG. 3. In FIG. 4, the position change corrector 18 outputs a position correction signal to a computing unit 13a1 based on the support-structure model position. The computing unit 13a1 outputs a second position deviation signal based on the position correction signal, the second position command, and the second electric motor position signal. The speed change corrector 19 outputs a speed correction signal to the computing unit 13d1 based on a support-structure model speed obtained by a differentiator 20 differentiating the support-structure model position. The computing unit 13d1 outputs a second speed deviation signal based on the second speed correction signal, the speed correction signal, and a signal obtained by the differentiator 13c differentiating an electric motor position signal. Other constituent elements in FIG. 4 are the same as those in FIG. 1.

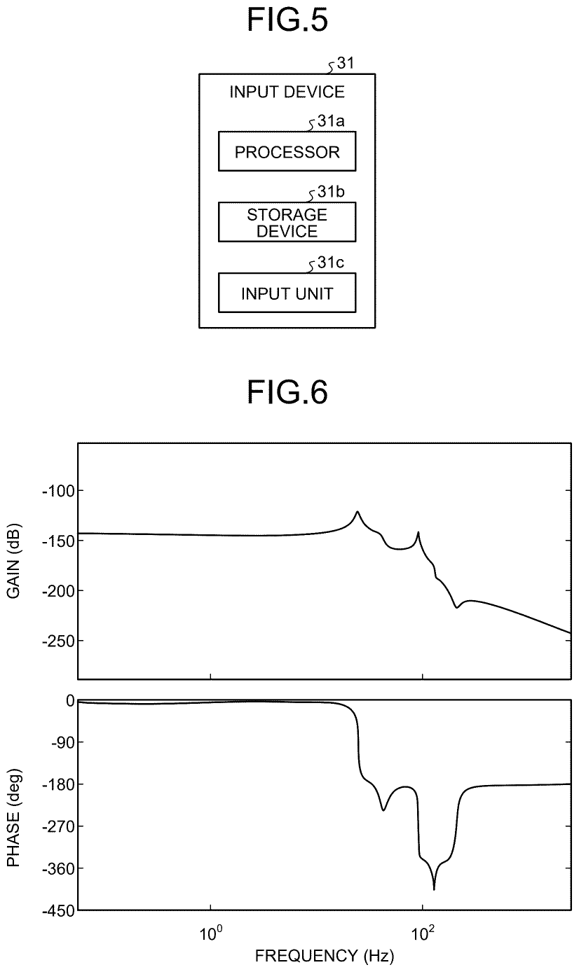

Parameters to be included in the support-structure state estimator 15 and the correction amount determiner 16A in FIG. 3 and the support-structure state estimator 15, the correction amount determiner 16B, the position change corrector 18, and the speed change corrector 19 in FIG. 4 are input from an input device 31 illustrated in FIG. 5. FIG. 5 is a diagram illustrating a configuration of the input device 31 according to the first embodiment. The input device 31 is a computer including a processor 31a, a storage device 31b, and an input unit 31c. The storage device 31b is implemented by, for example, a semiconductor memory. In the first embodiment, the input unit 31c is an input key. The input unit 31c is not limited to the input key.

In a case where any of the parameters to be included in the support-structure state estimator 15 and the correction amount determiner 16A in FIG. 3 and the support-structure state estimator 15, the correction amount determiner 16B, the position change corrector 18, and the speed change corrector 19 in FIG. 4 is changed, a user provides a value of a parameter to be changed to the input device 31 by using the input unit 31c. The processor 31a changes a value of the parameter to be changed, to the value provided by the input unit 31c. The storage device 31b can store a plurality of different parameters. The processor 31a may read a parameter stored in the storage device 31b and change the value of the parameter to be changed.

An effect of preventing the control performance of the second electric motor 3 from being deteriorated due to the driving of the first electric motor 2 is confirmed by an experiment. FIG. 6 is a Bode diagram illustrating a frequency response of a mechanical apparatus subjected to an experiment according to the first embodiment, the frequency response being from the first deviation reduction signal to the second machine-end relative displacement. The frequency response from the first deviation reduction signal to the second machine-end relative displacement has resonances around 25 Hz and around 90 Hz.

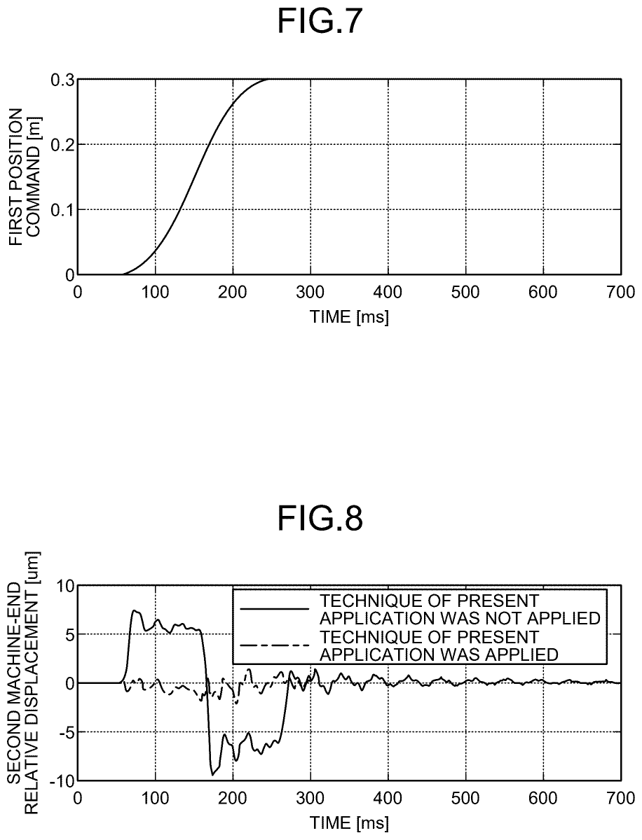

With reference to FIGS. 7 and 8, a description will be given of a result of an experiment of comparison between responses made when positioning operation was performed in a case where the motor control apparatus according to the first embodiment was used and in a case where the motor control apparatus according to the first embodiment was not used. FIG. 7 is a diagram illustrating the first position command. FIG. 8 is a diagram illustrating the result of the experiment of comparison between responses made when positioning operation was performed in the case where the motor control apparatus according to the first embodiment was used and in the case where the motor control apparatus according to the first embodiment was not used.

FIG. 8 illustrates the second machine-end relative displacement obtained when the first driver 4 was driven by the first position command. A solid line in FIG. 8 indicates a result obtained in a case where the motor control apparatus according to the first embodiment did not perform decoupling, and an alternate long and short dash line in FIG. 8 indicates a result obtained in a case where the motor control apparatus according to the first embodiment performed decoupling. In FIG. 8, the phrase “TECHNIQUE OF PRESENT APPLICATION WAS NOT APPLIED”, which indicates that the motor control apparatus according to the first embodiment did not perform decoupling, has been added to the solid line. In addition, the phrase “TECHNIQUE OF PRESENT APPLICATION WAS APPLIED”, which indicates that the motor control apparatus according to the first embodiment performed decoupling, has been added to the alternate long and short dash line. In the present experiment, the first position command is zero, and the first electric motor 2 and the second electric motor 3 remain stationary, for about 50 ms from the start of the experiment. After a lapse of about 50 ms from the start of the experiment, the first position command gradually increases, and reaches 0.3 m when about 280 ms has elapsed. After a lapse of about 280 ms, the first position command remains at a steady-state value of 0.3 m. The second position command is zero from the start of the experiment to the end of the experiment.

As is clear from FIG. 8, displacement of the second machine-end relative displacement particularly during acceleration/deceleration of the first electric motor 2 could be reduced by decoupling performed by the motor control apparatus according to the first embodiment. Thus, the effect of the decoupling performed by the motor control apparatus according to the first embodiment has been confirmed.

As described above, the motor control apparatus according to the first embodiment can prevent control performance of one of two electric motors from being deteriorated due to the driving of the other electric motor. Furthermore, parameters included in the support-structure state estimator 15 and the correction amount determiner 16A in FIG. 3 and the support-structure state estimator 15, the position change corrector 18, the speed change corrector 19, and the correction amount determiner 16B in FIG. 4, which are compensators that decouple influence of shafts on each other, have physical meanings. Therefore, the motor control apparatus according to the first embodiment can determine, in a short time, the characteristics of the compensators that decouple the influence of the shafts on each other. That is, the motor control apparatus according to the first embodiment can prevent interference between shafts, and can adjust, in a short time, the compensators that decouple influence of the shafts on each other.

Note that the support-structure state estimator 15 determines the support-structure model position based on at least one of the damping ratio of the support structure 1, the damping coefficient of the support structure 1, the natural angular frequency of the support structure 1, the spring constant of the support structure 1, and the mass of the support structure 1.

The correction amount determiner 16A determines the displacement correction signal based on at least one of the mass of the second driver 5 to be driven by the second electric motor 3, the moment of inertia of the second driver 5, the mass of the mover 3b of the second electric motor 3, the moment of inertia of the mover 3b of the second electric motor 3, the transfer characteristic of the second controller 13, and the support-structure vibration amplitude ratio that is an amplitude ratio between vibrations at two locations on the support structure 1.

The reference driving force signal that is a signal representing a force for driving the mover 2b of the first electric motor 2 is any one of a first model driving force, the first deviation reduction signal, and a first electric motor drive signal. The first model driving force is a driving force ideal for the position of the mover 2b of the first electric motor 2 in following a signal based on the first position command for determining the position of the first electric motor 2. The first deviation reduction signal is a signal for driving the mover 2b of the first electric motor 2 in such a way as to reduce a difference between the signal based on the first position command and the first electric motor position signal. The first electric motor drive signal is calculated based on the first model driving force and the first deviation reduction signal.

### Second Embodiment

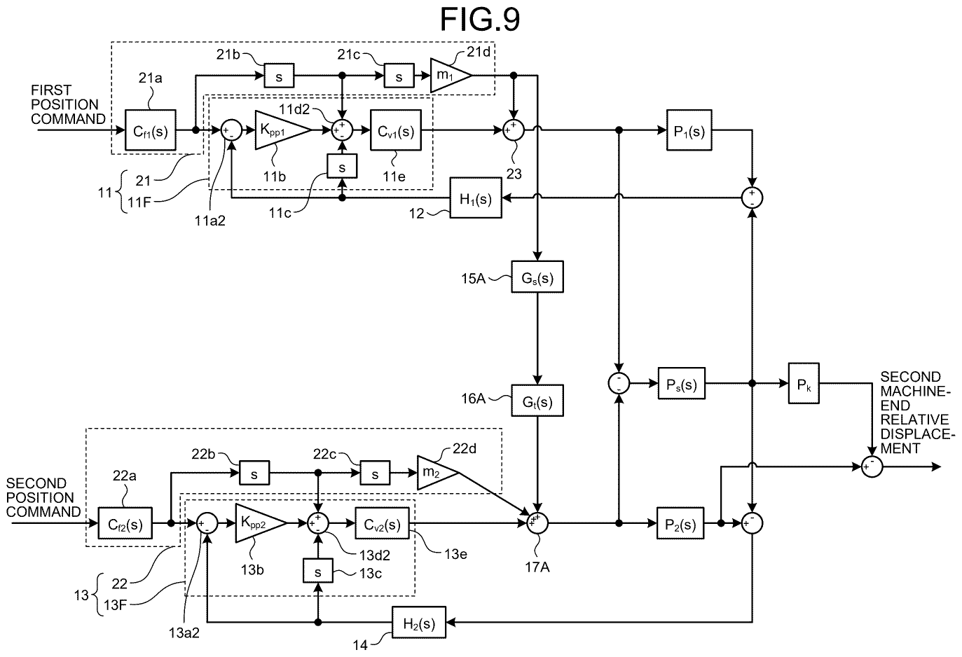

FIG. 9 is a diagram illustrating a configuration of a system including a motor control apparatus according to a second embodiment. In the second embodiment, a first feedforward compensator 21 that performs first feedforward compensation is added to the first controller 11 of the first embodiment. In addition, a second feedforward compensator 22 that performs second feedforward compensation is added to the second controller 13 of the first embodiment. That is, the motor control apparatus according to the second embodiment includes the first controller 11 and the second controller 13. The first controller 11 includes a first feedback controller 11F and the first feedforward compensator 21. The second controller 13 includes a second feedback controller 13F and the second feedforward compensator 22. A computing unit 23 is also added. In addition, a support-structure state estimator 15A is different from the support-structure state estimator 15 of the first embodiment in that the support-structure state estimator 15A estimates a support-structure model position based on a first model driving force which is one of outputs of the first feedforward compensator 21. Description of overlaps between the first embodiment and the second embodiment is omitted in the second embodiment.

In the second embodiment, the first controller 11 includes the first feedforward compensator 21 and the first feedback controller 11F, as described above. The first feedforward compensator 21 calculates a first model position, a first model speed, and the first model driving force based on the first position command, and outputs a calculation result to the first feedback controller 11F. In the second embodiment, the first model driving force corresponds to a reference driving force signal. The reference driving force signal is not limited to the first model driving force, and may be a first electric motor drive signal that is the sum of the first model driving force and the first deviation reduction signal.

The first model position is determined based on the first position command and a low-pass filter 21a that attenuates high-frequency components. A transfer characteristic of the low-pass filter 21a is expressed as C_{f1}(s). In the second embodiment, the low-pass filter 21a is a first-order low-pass filter. The low-pass filter 21a is not limited to the low-pass filter. The first model speed is determined based on the first model position and a differentiator 21b that performs a differential operation. The first model speed differentiated by a differentiator 21c is multiplied by a proportional gain 21d to obtain the first model driving force. The proportional gain 21d multiplies an input signal by m₁. The symbol “m₁” denotes the sum of the mass of the first driver 4 and the mass of the mover 2b.

The first feedback controller 11F determines the first deviation reduction signal based on the first model position and the first electric motor position signal. A computing unit 11a2 subtracts the first electric motor position signal from the first model position to output a first position deviation signal. A computing unit 11d2 outputs a first speed deviation signal based on the first model speed, the first speed correction signal, and the first electric motor position signal that has been differentiated.

The computing unit 23 outputs a first electric motor drive signal based on the first deviation reduction signal and the first model driving force. The mover 2b is driven based on the first electric motor drive signal.

As described above, the second controller 13 includes the second feedforward compensator 22 and the second feedback controller 13F. The second feedforward compensator 22 calculates a second model position, a second model speed, and a second model driving force based on the second position command, and outputs a calculation result to the second feedback controller 13F. The second model position is determined based on the second position command and a low-pass filter 22a that attenuates high-frequency components. A transfer characteristic of the low-pass filter 22a is expressed as C_{f2}(s). In the second embodiment, the low-pass filter 22a is a first-order low-pass filter. The low-pass filter 22a is not limited to the first-order low-pass filter.

The second model speed is determined based on the second model position and a differentiator 22b that performs a differential operation. The second model speed differentiated by a differentiator 22c is multiplied by a proportional gain 22d to obtain the second model driving force. The proportional gain 22d multiplies an input signal by m₂. The symbol “m₂” denotes the sum of the mass of the mover 3b of the second electric motor 3 and the mass of the second driver 5.

The second feedback controller 13F determines the second deviation reduction signal based on the second model position and the second electric motor position signal. A computing unit 13a2 subtracts the second electric motor position signal from the second model position to output a second position deviation signal. A computing unit 13d2 outputs a second speed deviation signal based on the second model speed, the second speed correction signal, and the second electric motor position signal that has been differentiated.

The transfer characteristic of the second controller 13 in the second embodiment corresponds to a transfer characteristic from the second electric motor position signal to the second deviation reduction signal, and is expressed by formula (6).

A computing unit 17A outputs a corrected motor drive signal based on the second deviation reduction signal, the second model driving force, and the displacement correction signal. The mover 3b is driven based on the corrected motor drive signal.

Note that the diagram illustrating the configuration of the system including the motor control apparatus according to the second embodiment is not limited to FIG. 9, and may be a diagram obtained by equivalent transformation of FIG. 9.

As described above, according to the motor control apparatus of the second embodiment, it is possible to obtain an effect of eliminating the influence of noise included in the detector 12 from a displacement correction signal by estimating a support-structure model position on the basis of the first model driving force and the support-structure state estimator 15A and determining the displacement correction signal on the basis of the support-structure model position and the correction amount determiner 16A.

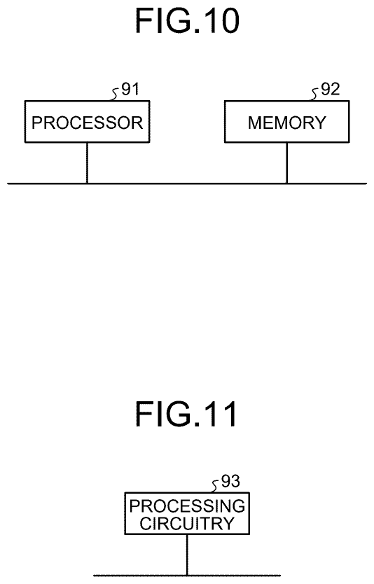

FIG. 10 is a diagram illustrating a processor 91 that implements at least some of functions of the first controller 11, the detector 12, the second controller 13, the detector 14, the support-structure state estimator 15, the correction amount determiner 16A, and the computing unit 17 included in the motor control apparatus according to the first embodiment. That is, at least some of the functions of the first controller 11, the detector 12, the second controller 13, the detector 14, the support-structure state estimator 15, the correction amount determiner 16A, and the computing unit 17 may be implemented by the processor 91 that executes programs stored in a memory 92. The processor 91 is a central processing unit (CPU), a processing system, an arithmetic system, a microprocessor, or a digital signal processor (DSP). FIG. 8 also illustrates the memory 92.

When at least some of the functions of the first controller 11, the detector 12, the second controller 13, the detector 14, the support-structure state estimator 15, the correction amount determiner 16A, and the computing unit 17 are implemented by the processor 91, the at least some functions are each implemented by the processor 91 and software, firmware, or a combination of software and firmware. The software or firmware is described as a program and stored in the memory 92. The processor 91 reads and executes programs stored in the memory 92 to implement at least some of the functions of the first controller 11, the detector 12, the second controller 13, the detector 14, the support-structure state estimator 15, the correction amount determiner 16A, and the computing unit 17.

When at least some of the functions of the first controller 11, the detector 12, the second controller 13, the detector 14, the support-structure state estimator 15, the correction amount determiner 16A, and the computing unit 17 are implemented by the processor 91, the motor control apparatus according to the first embodiment includes the memory 92 for storing programs that cause at least some of steps to be executed, the steps being to be executed by the first controller 11, the detector 12, the second controller 13, the detector 14, the support-structure state estimator 15, the correction amount determiner 16A, and the computing unit 17. It can also be said that the programs stored in the memory 92 cause a computer to execute at least some of procedures or methods to be performed by the first controller 11, the detector 12, the second controller 13, the detector 14, the support-structure state estimator 15, the correction amount determiner 16A, and the computing unit 17.

Examples of the memory 92 include a nonvolatile or volatile semiconductor memories such as a random access memory (RAM), a read only memory (ROM), a flash memory, an erasable programmable read only memory (EPROM), and an electrically erasable programmable read-only memory (EEPROM (registered trademark)); a magnetic disk; a flexible disk; an optical disk; a compact disk; a mini disk; a digital versatile disk (DVD); or the like.

FIG. 11 is a diagram illustrating processing circuitry 93 that implements at least some of the functions of the first controller 11, the detector 12, the second controller 13, the detector 14, the support-structure state estimator 15, the correction amount determiner 16A, and the computing unit 17 included in the motor control apparatus according to the first embodiment. That is, at least some of the functions of the first controller 11, the detector 12, the second controller 13, the detector 14, the support-structure state estimator 15, the correction amount determiner 16A, and the computing unit 17 may be implemented by the processing circuitry 93.

The processing circuitry 93 is dedicated hardware. Examples of the processing circuitry 93 include a single circuit, a composite circuit, a programmed processor, a parallel-programmed processor, an application specific integrated circuit (ASIC), a field-programmable gate array (FPGA), or a combination thereof.

Some of the functions of the first controller 11, the detector 12, the second controller 13, the detector 14, the support-structure state estimator 15, the correction amount determiner 16A, and the computing unit 17 may be implemented by dedicated hardware different from hardware that implements the rest of the functions of the first controller 11, the detector 12, the second controller 13, the detector 14, the support-structure state estimator 15, the correction amount determiner 16A, and the computing unit 17 included in the motor control apparatus.

Some of a plurality of functions of the first controller 11, the detector 12, the second controller 13, the detector 14, the support-structure state estimator 15, the correction amount determiner 16A, and the computing unit 17 may be implemented by software or firmware, and the rest of the plurality of functions may be implemented by dedicated hardware. As described above, the plurality of functions of the first controller 11, the detector 12, the second controller 13, the detector 14, the support-structure state estimator 15, the correction amount determiner 16A, and the computing unit 17 can be implemented by hardware, software, firmware, or a combination thereof.

At least some of functions of the computing unit 11a, the proportional gain output unit 11b, the differentiator 11c, the computing unit 11d, the first speed controller 11e, the detector 12, the computing unit 13a1, the proportional gain output unit 13b, the differentiator 13c, the computing unit 13d1, the second speed controller 13e, the detector 14, the support-structure state estimator 15, the correction amount determiner 16B, the computing unit 17, the position change corrector 18, the speed change corrector 19, and the differentiator 20 illustrated in FIG. 4 may be implemented by a processor that executes programs stored in a memory, or may be implemented by processing circuitry. The memory is a memory equivalent to the memory 92, the processor is a processor equivalent to the processor 91, and the processing circuitry is processing circuitry equivalent to the processing circuitry 93.

At least some of functions of the first controller 11, the detector 12, the second controller 13, the detector 14, the support-structure state estimator 15A, the correction amount determiner 16A, and the computing unit 17A illustrated in FIG. 9 may be implemented by a processor that executes programs stored in a memory, or may be implemented by processing circuitry. The memory is a memory equivalent to the memory 92, the processor is a processor equivalent to the processor 91, and the processing circuitry is processing circuitry equivalent to the processing circuitry 93.

The configurations set forth in the above embodiments show examples, and it is possible to combine the configurations with another known technique or combine the embodiments with each other, and is also possible to partially omit or change the configurations without departing from the gist of the present disclosure.

### REFERENCE SIGNS LIST

1 support structure; la support structure side surface; 1b support structure upper portion; 1c support structure lower portion; 2 first electric motor; 2a, 3a stator; 2b, 3b mover; 3 second electric motor: 4 first driver; 4a, 5a drive unit; 4b, 5b work tool; 5 second driver; 6, 7 workpiece; 8 leveling block; 11 first controller; 11a, 11a2, 11d, 11d2, 13a, 13a1, 13a2, 13d, 13d1, 13d2, 17, 17A, 23 computing unit; 11b, 13b proportional gain output unit; 11c, 13c, 20, 21b, 21c, 22b, 22c differentiator; 11e first speed controller; 11F first feedback controller; 12, 14 detector; 13 second controller; 13e second speed controller; 13F second feedback controller; 15, 15A support-structure state estimator; 16A, 16B correction amount determiner; 18 position change corrector; 19 speed change corrector; 21 first feedforward compensator; 21a, 22a low-pass filter; 21d, 22d proportional gain; 22 second feedforward compensator; 31 input device; 31a, 91 processor; 31b storage device; 31c input unit; 92 memory; 93 processing circuitry; 100 mechanical apparatus.

1. A motor control apparatus comprising:
a support-structure state estimating circuitry to determine a support-structure model position based on a reference driving force signal, the support-structure model position being an estimated value of an absolute position of a support structure that is elastically deformed by a reaction force of driving of a mover of a first electric motor installed on the support structure, the reference driving force signal being a signal representing a force for driving the mover of the first electric motor;
a second controller to determine a second deviation reduction signal, the second deviation reduction signal being a signal for driving a second electric motor in such a way as to reduce a difference between a signal based on a second position command and a second electric motor position signal, the second electric motor being different from the first electric motor and installed on the support structure, the second position command specifying a position of a mover of the second electric motor, the second electric motor position signal indicating a position of the mover of the second electric motor relative to a stator of the second electric motor;
a correction amount determining circuitry to determine a displacement correction signal based on the support-structure model position determined by the support-structure state estimating circuitry; and
a computing circuitry to determine a corrected motor drive signal based on the displacement correction signal and the second deviation reduction signal, the second electric motor being driven by the corrected motor drive signal, the displacement correction signal being determined by the correction amount determining circuitry, the second deviation reduction signal being determined by the second controller.

2. The motor control apparatus according to claim 1, wherein the support-structure state estimating circuitry performs calculation represented by a transfer function including a second-order vibration system.

3. The motor control apparatus according to claim 1, wherein the support-structure state estimating circuitry determines the support-structure model position based on at least one of a damping ratio of the support structure, a damping coefficient of the support structure, a natural angular frequency of the support structure, a spring constant of the support structure, and a mass of the support structure.

4. The motor control apparatus according to claim 1, wherein the correction amount determining circuitry determines the displacement correction signal based on at least one of a mass of a second driver, a moment of inertia of the second driver, a mass of the mover of the second electric motor, a moment of inertia of the mover of the second electric motor, a transfer characteristic of the second controller, and a support-structure vibration amplitude ratio, the second driver being driven by the second electric motor, the support-structure vibration amplitude ratio being an amplitude ratio between vibrations at two locations on the support structure.

5. The motor control apparatus according to claim 1, wherein the reference driving force signal is any one of a first model driving force, a first deviation reduction signal, and a first electric motor drive signal, the first model driving force being a driving force ideal for a position of the mover of the first electric motor in following a signal based on a first position command for determining a position of the first electric motor, the first deviation reduction signal being a signal for driving the mover of the first electric motor in such a way as to reduce a difference between the signal based on the first position command and a first electric motor position signal, the first electric motor drive signal being calculated based on the first model driving force and the first deviation reduction signal.

6. A mechanical apparatus comprising:
the support structure;
the first electric motor;
the second electric motor; and
the motor control apparatus according to claim 1.

7. A mechanical apparatus comprising:
the support structure;
the first electric motor;
the second electric motor; and
the motor control apparatus according to claim 2.

8. A mechanical apparatus comprising:
the support structure;
the first electric motor;
the second electric motor; and
the motor control apparatus according to claim 3.

9. A mechanical apparatus comprising:
the support structure;
the first electric motor;
the second electric motor; and
the motor control apparatus according to claim 4.
